(19) United States
(12) Patent Application Publication
(10) Pub. No.: US 2008/0240149 A1
(43) Pub. Date: Oct. 2, 2008

(54) Sharing channel estimates in cooperative wireless networks

(76) Inventor: Timothy F. Cox, Palo Alto, CA (US)

Correspondence Address: CAVEN & AGHEVLI;c/o INTELLEVATE, LLC, P.O. BOX 52050, MINNEAPOLIS, MN, 55402, US

(21) Appl. No.: 11/729,681

(22) Filed: Mar. 29, 2007

(51) Int. Cl. H04J 11/00

(52) U.S. Cl. 370/463; 375/260

(57) ABSTRACT

Methods and apparatus to share channel estimates in cooperative wireless networks are described. In one embodiment, channel information of first wireless device may be transmitted to a second wireless device via a crosslink. Other embodiments are also described.

### BACKGROUND

The present disclosure generally relates to the field of electronics. More particularly, an embodiment of the invention generally relates to techniques for sharing channel estimates in cooperative wireless networks.

Wireless networks have become an integral part of computing. In some current implementations, various nodes in a wireless network may attempt to cooperate by sharing operational parameters such as multiple input, multiple output (MIMO) channel estimations. For example, sharing of MIMO channel estimations may reduce latency associated with communicating data with a relatively more remote destination node than a node in the same network. According to some communication protocols, sharing of such operational parameters among cooperative wireless nodes may rely on the knowledge of physical layer protocol (PHY) link channel characteristics between these nodes and the destination node. This approach may however introduce latency and inefficiencies in bandwidth utilization and sharing of operational parameters.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1-2 illustrate various components of embodiments of communication systems, which may be utilized to implement one or more embodiments.

FIG. 3 illustrates various components of an embodiment of a communication system, which may be utilized to implement one or more embodiments of the invention.

FIGS. 4-5 illustrate flow diagram of methods, according to some embodiments of the invention.

FIG. 6 illustrates a block diagram of an embodiment of a computing system, which may be utilized to implement various embodiments discussed herein.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention. Further, various aspects of embodiments of the invention may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

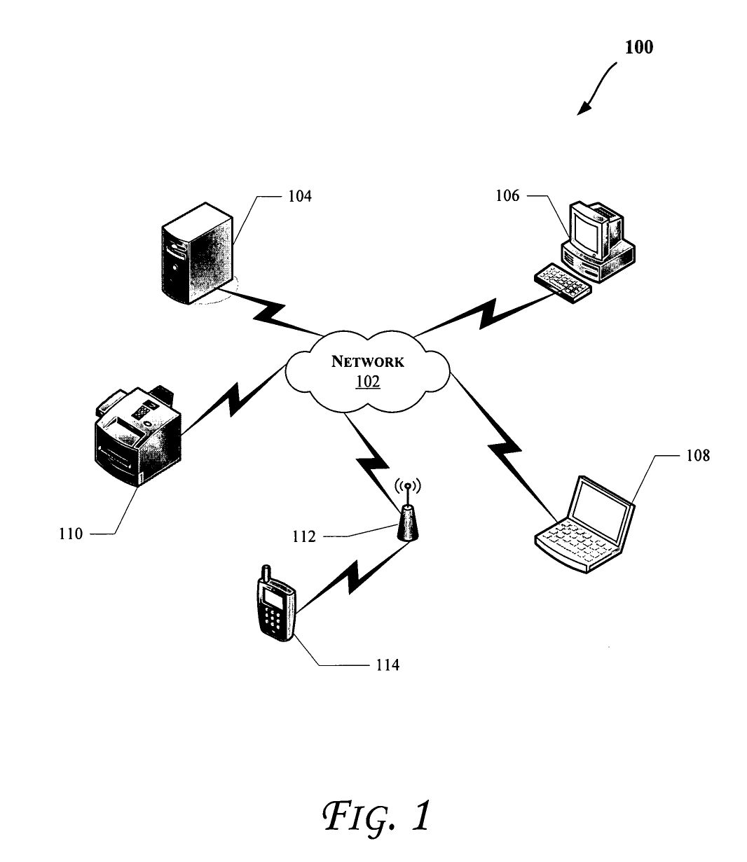

In some embodiments, methods and apparatus for the efficient sharing of the user channel estimates over a user-to-user crosslink are described. Furthermore, some of the embodiments discussed herein may be applied in various computing environments such as those discussed with reference to FIGS. 1-6. More particularly, FIG. 1 illustrates various components of an embodiment of a communication system 100, which may be utilized to implement some embodiments discussed herein. The system 100 may include a network 102 to enable communication between various devices such as a server computer 104, a desktop computer 106 (e.g., a workstation or a desktop computer), a laptop (or notebook) computer 108, a reproduction device 110 (e.g., a network printer, copier, facsimile, scanner, all-in-one device, etc.), a wireless access point 112, a personal digital assistant or smart phone 114, a rack-mounted computing system (not shown), etc. The network 102 may be any type of type of a computer network including an intranet, the Internet, and/or combinations thereof.

The devices 104-114 may communicate with the network 102 through wired and/or wireless connections. Hence, the network 102 may be a wired and/or wireless network. For example, as illustrated in FIG. 1, the wireless access point 112 may be coupled to the network 102 to enable other wireless-capable devices (such as the device 114) to communicate with the network 102. In some embodiments, more than one access point 112 may be in communication with the network 102. In one embodiment, the wireless access point 112 may include traffic management capabilities. Also, data communicated between the devices 104-114 may be encrypted (or cryptographically secured), e.g., to limit unauthorized access.

The network 102 may utilize any communication protocol such as Ethernet, Fast Ethernet, Gigabit Ethernet, wide-area network (WAN), fiber distributed data interface (FDDI), Token Ring, leased line, analog modem, digital subscriber line (DSL and its varieties such as high bit-rate DSL (HDSL), integrated services digital network DSL (IDSL), etc.), asynchronous transfer mode (ATM), cable modem, and/or FireWire.

Wireless communication through the network 102 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), etc. Moreover, network communication may be established by internal network interface devices (e.g., present within the same physical enclosure as a computing system) such as a network interface card (NIC) or external network interface devices (e.g., having a separate physical enclosure and/or power supply than the computing system to which it is coupled).

Referring to FIG. 2, a block diagram of a wireless local area or cellular network communication system 200 in accordance with one or more embodiments of the invention will be discussed. In the communication system 200 shown in FIG. 2, a wireless device 210 may include a wireless transceiver 212 to couple to an antenna 218 and to a logic 214 such as a processor (e.g., to provide baseband and media access control (MAC) processing functions). In some embodiment, one or more of the devices 104, 106, 108, 110, or 114 of FIG. 1 may include one or more of the components discussed with reference to the wireless device 210. Hence, in an embodiment, the devices 104, 106, 108, 110, or 114 of FIG. 1 may be the same or similar to the wireless device 210. In one embodiment of the invention, wireless device 210 may be a cellular telephone or an information handling system such as a mobile personal computer or a personal digital assistant or the like that incorporates a cellular telephone communication module. Logic 214 in one embodiment may comprise a single processor, or alternatively may comprise a baseband processor and an applications processor. Logic 214 may couple to a memory 216 which may include volatile memory such as dynamic random-access memory (DRAM), non-volatile memory such as flash memory, or alternatively may include other types of storage such as a hard disk drive. Some portion or all of memory 216 may be included on the same integrated circuit as logic 214, or alternatively some portion or all of memory 216 may be disposed on an integrated circuit or other medium, for example a hard disk drive, that is external to the integrated circuit of logic 214.

Wireless device 210 may communicate with access point 222 via a wireless communication link, where access point 222 may include one or more: antenna(s) 220, transceiver(s) 224, processor(s) 226, and memory(s) 228. In one embodiment, access point 222 may be a base station of a cellular telephone network, and in an embodiment, access point 222 may be a an access point or wireless router of a wireless local or personal area network. In some embodiment, the access point 112 of FIG. 1 may include one or more of the components discussed with reference to the access point 222. Hence, in an embodiment, the access point 112 of FIG. 1 may be the same or similar to the access point 222. In an embodiment, access point 222 (and optionally wireless device 210) may include two or more antennas, for example to provide a spatial division multiple access (SDMA) system or a multiple input, multiple output (MIMO) system. Access point 222 may couple with network 230 (which may be the same or similar to the network 102 of FIG. 1 in some embodiments) so that wireless device 210 may communicate with network 230, including devices coupled to network 230 (e.g., one or more of the devices 104-114), by communicating with access point 222 via a wireless communication link. Network 230 may include a public network such as a telephone network or the Internet, or alternatively network 230 may include a private network such as an intranet, or a combination of a public and a private network. Communication between wireless device 210 and access point 222 may be implemented via a wireless local area network (WLAN). In one embodiment, communication between wireless device 210 and access point 222 may be at least partially implemented via a cellular communication network compliant with a Third Generation Partnership Project (3GPP or 3G) standard. In some embodiments, antenna 218 may be utilized in a wireless sensor network or a mesh network.

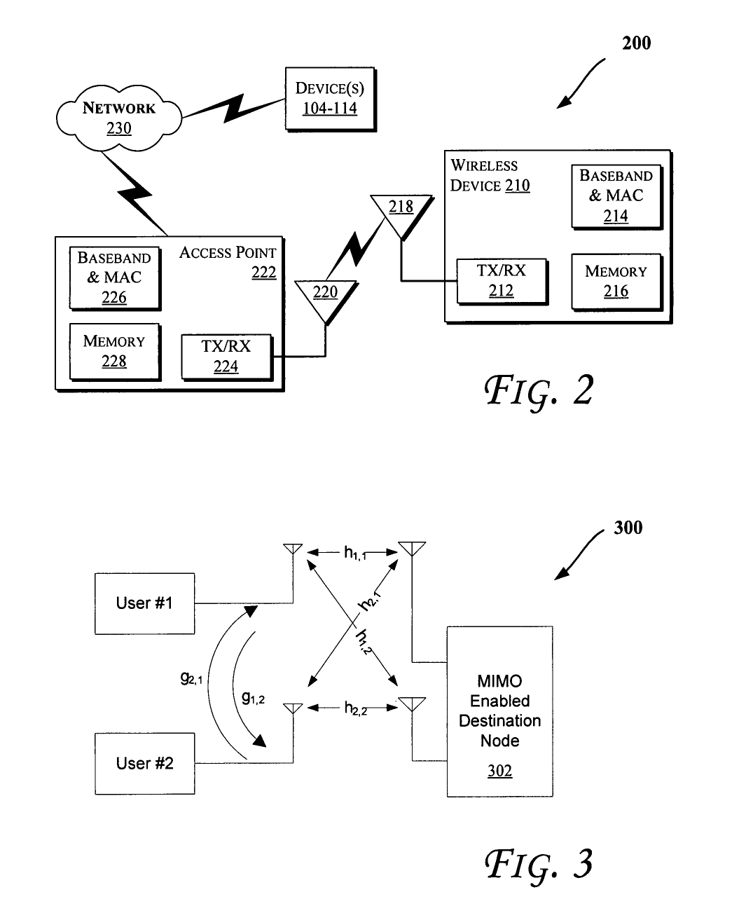

FIG. 3 illustrates various components of an embodiment of a communication system 300, which may be utilized to implement one or more embodiments of the invention. In FIG. 3, some sample MIMO channel responses for a two-by-two configuration are shown. In particular, transfer functions h_{1,1}, h_{1,2}, h_{2,1}, and h_{2,2} may be mathematical representations for amplitude and phase of the corresponding transmission path. For example, “h_{1,1}” may correspond to the transfer function of the transmission path from the antenna of user #1 to the first antenna of a MIMO enabled destination node 302, “h_{2,1}” may correspond to the transfer function of the transmission path from the antenna of user #2 to the first antenna of the MIMO enabled destination node 302, etc. In an embodiment, the MIMO node 302 may be a wireless access point (such as the access point 222 of FIG. 2). In some embodiments, each of the users #1 and #2 may include one or more components of the wireless device 210 and/or the access point 222 of FIG. 2.

As illustrated in FIG. 3, the users may be separated and may not have knowledge regarding the full MIMO channel characteristics through the “h” channel responses. Specifically, user #1 may not have the channel sounding information for the estimation of h_{2,1} or h_{2,2} and user #2 may not have the channel sounding information for the estimation of h_{1,1} or h_{1,2}. To enable this information sharing, a crosslink between the users may provision the data exchange as shown in FIG. 3 (e.g., and designated by “g”). For example, “g_{1,2}” may correspond to the transfer function of the transmission path from the antenna of user #1 to the antenna of user #2 and “g_{2,1}” may correspond to the transfer function of the transmission path from the antenna of user #2 to the antenna of user #1. Accordingly, in some embodiments, a crosslink may be used to communicate channel information of a first wireless device to a second wireless device. The communicated channel information may then be used by the second wireless device to establish a communication channel with a MIMO node (e.g., 302), e.g., through the first wireless device.

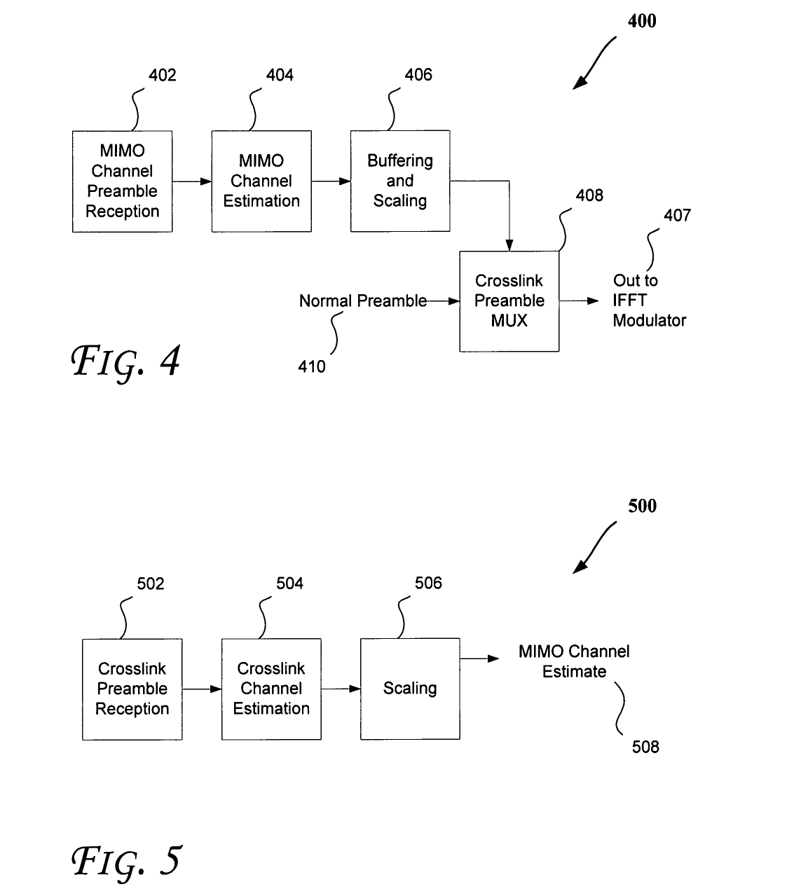

Referring to FIGS. 4 and 5, flow diagrams of embodiments of methods 400 and 500 to perform operations respectively on the transmit side and receive side are illustrated. In some embodiments, various components discussed with reference to FIGS. 1-3 and/or 6 may be used to perform one or more of the operations of methods 400 and/or 500.

Referring to FIGS. 1-4, various operations of methods 400 will now be discussed with reference to tasks that may be performed by user #1 of FIG. 3 for simplicity. However, the same or similar operations may be performed by user #2 of FIG. 3, e.g., when user #2 is on the transmit side of a communication. At an operation 402, user #1 may receive MIMO channel preambles (e.g., in accordance with the Institute of Electrical & Electronics Engineers (IEEE) specification 802.11n (March 2006) and/or specification 802.16e (February 2006), etc.).

At an operation 404, user #1 may obtain estimates of h_{1,1} and h_{1,2} from the reception of the normal frame preamble, e.g., assuming reciprocity of the MIMO channels. These estimates may be processed at operation 406 (e.g., by buffering the values in a portion of the memories 216 or 228 and scaling them by logic 214 or 226) to obtain operational parameters including, for example, carrier to interface plus noise ratio (CINR) metrics. In an embodiment, at operation 406, the estimate \tilde{h}_{1,1} may be normalized by scaling it with the ratio of the normal preamble “p” to the modulus of \tilde{h}_{1,1} (also known as its complex norm) “|\tilde{h}_{1,1}|.” The normalized estimate

$$“ \frac{{\hat{h}}_{1 , 1}}{\vert {\hat{h}}_{1 , 1} \vert} p ”$$

may be scaled by the square root of the ratio of the h_{1,1} CINR to the maximum CINR and passed to the g_{1,2} frame buffer (e.g., which may be a portion of the memories 216 or 228) prior to inverse fast Fourier transform (IFFT) modulator (407) for transmission over the antenna of user #1. The maximum CINR may be an operational parameter known to both user #1 and user #2.

Also, in some embodiments, the estimate \tilde{h}_{1,2} may be normalized by scaling it with the ratio of the normal preamble “p” to |\tilde{h}_{1,2}|. The normalized estimate

$$“ \frac{{\hat{h}}_{1 , 2}}{\vert {\hat{h}}_{1 , 2} \vert} p ”$$

may be scaled by the square root of the ratio of the h_{1,2} CINR to the maximum CINR and passed to the g_{1,2} frame buffer (e.g., which may be a portion of the memories 216 or 228) for transmission to user #2. At an operation 408, a crosslink frame structure for the g_{1,2} link may be obtained based on a time division multiplexing of the normal preamble 410 and the scales of MIMO channel estimates from operation 406. For example, over a three frame span the order may be

$$\{ p ; \frac{{\hat{h}}_{1 , 1}}{\vert {\hat{h}}_{1 , 1} \vert} p \sqrt{\frac{{CINR}_{{h}_{1 , 1}}}{{CINR}_{MAX}}} ; \frac{{\hat{h}}_{1 , 2}}{\vert {\hat{h}}_{1 , 2} \vert} p \sqrt{\frac{{CINR}_{{h}_{1 , 2}}}{{CINR}_{MAX}}} \} .$$

Referring to FIGS. 1-5, various operations of methods 500 will now be discussed with reference to tasks that may be performed by user #2 of FIG. 3 for simplicity. However, the same or similar operations may be performed by user #1 of FIG. 3, e.g., when user #1 is on the receive side of a communication. At an operation 502, user #2 may receive the crosslink preamble of operation 408 through the crosslink g_{1,2}. At an operation 504, estimates of the received crosslink preamble may be obtained by user #2 (e.g., by buffering the values in a portion of the memories 216 or 228 and scaling them by logic 214 or 226). At an operation 506, the estimates of operation 504 may be scaled. In an embodiment, at operation 504, user #2 may process the normal preamble to obtain \tilde{g}_{1,2}. User #2 may then use this value for scaling at operation 506 to generate a MIMO channel estimate 508.

In some embodiments, the scaled MIMO channel estimates may be received during the alternate frames and processed to remove the effects of g_{1,2}. The relationships may be as follows in one embodiment:

$$\begin{matrix}{\tilde{h}}_{1 , 1} = \underbrace{\sqrt{{CINR}_{{h}_{1 , 1}}} \frac{{\hat{h}}_{1 , 1}}{\vert {\hat{h}}_{1 , 1} \vert}}_{Desired MIMO Channel Estimate} \\ = \underbrace{( \frac{{\hat{h}}_{1 , 1}}{\vert {\hat{h}}_{1 , 1} \vert} p \sqrt{\frac{{CINR}_{{h}_{1 , 1}}}{{CINR}_{MAX}}} ) \cdot {g}_{1 , 2}}_{\begin{matrix}Scaled MIMO Channel \\ Estimate from Crosslink\end{matrix}} \cdot \underbrace{( \frac{\sqrt{{CINR}_{MAX}}}{p {\hat{g}}_{1 , 2}} )}_{Scaling from Operation 506}\end{matrix}$$

$$\begin{matrix}{\tilde{h}}_{1 , 2} = \underbrace{\sqrt{{CINR}_{{h}_{1 , 2}}} \frac{{\hat{h}}_{1 , 2}}{\vert {\hat{h}}_{1 , 2} \vert}}_{Desired MIMO Channel Estimate} \\ = \underbrace{( \frac{{\hat{h}}_{1 , 2}}{\vert {\hat{h}}_{1 , 2} \vert} p \sqrt{\frac{{CINR}_{{h}_{1 , 2}}}{{CINR}_{MAX}}} ) \cdot {g}_{1 , 2}}_{\begin{matrix}Scaled MIMO Channel \\ Estimate from Crosslink\end{matrix}} \cdot \underbrace{( \frac{\sqrt{{CINR}_{MAX}}}{p {\hat{g}}_{1 , 2}} )}_{Scaling from Operation 506}\end{matrix}$$

In an embodiment, similar operations may be performed for the other MIMO channel estimates by user #1 as follows:

$$\begin{matrix}{\tilde{h}}_{2 , 1} = \underbrace{\sqrt{{CINR}_{{h}_{2 , 1}}} \frac{{\hat{h}}_{2 , 1}}{\vert {\hat{h}}_{2 , 1} \vert}}_{Desired MIMO Channel Estimate} \\ = \underbrace{( \frac{{\hat{h}}_{2 , 1}}{\vert {\hat{h}}_{2 , 1} \vert} p \sqrt{\frac{{CINR}_{{h}_{2 , 1}}}{{CINR}_{MAX}}} ) \cdot {g}_{2 , 1}}_{\begin{matrix}Scaled MIMO Channel \\ Estimate from Crosslink\end{matrix}} \cdot \underbrace{( \frac{\sqrt{{CINR}_{MAX}}}{p {\hat{g}}_{2 , 1}} )}_{Scaling from Operation 506}\end{matrix}$$

$$\begin{matrix}{\tilde{h}}_{2 , 2} = \underbrace{\sqrt{{CINR}_{{h}_{2 , 2}}} \frac{{\hat{h}}_{2 , 2}}{\vert {\hat{h}}_{2 , 2} \vert}}_{Desired MIMO Channel Estimate} \\ = \underbrace{( \frac{{\hat{h}}_{2 , 2}}{\vert {\hat{h}}_{2 , 2} \vert} p \sqrt{\frac{{CINR}_{{h}_{2 , 2}}}{{CINR}_{MAX}}} ) \cdot {g}_{2 , 1}}_{\begin{matrix}Scaled MIMO Channel \\ Estimate from Crosslink\end{matrix}} \cdot \underbrace{( \frac{\sqrt{{CINR}_{MAX}}}{p {\hat{g}}_{2 , 1}} )}_{Scaling from Operation 506}\end{matrix}$$

Additionally, an embodiment of the invention may rely on the transmit cluster characteristic that the crosslinks are of relatively high quality so that transmission of the estimates in this analog fashion does not incur an appreciable degradation. Hence, some embodiments may reduce or totally avoid the latency of the data flow pipeline. For example, an embodiment of the invention may use only one orthogonal frequency division multiplexing (OFDM) symbol per MIMO channel estimate that is not part of the normal data allocation. Hence, in an embodiment, channel estimates may be used in the “analog” form to yield MIMO channel estimate sharing in the cooperative domain. This may provide for bandwidth efficiency, e.g., for relatively high quality crosslinks enjoyed by transmit cluster types of cooperative topologies.

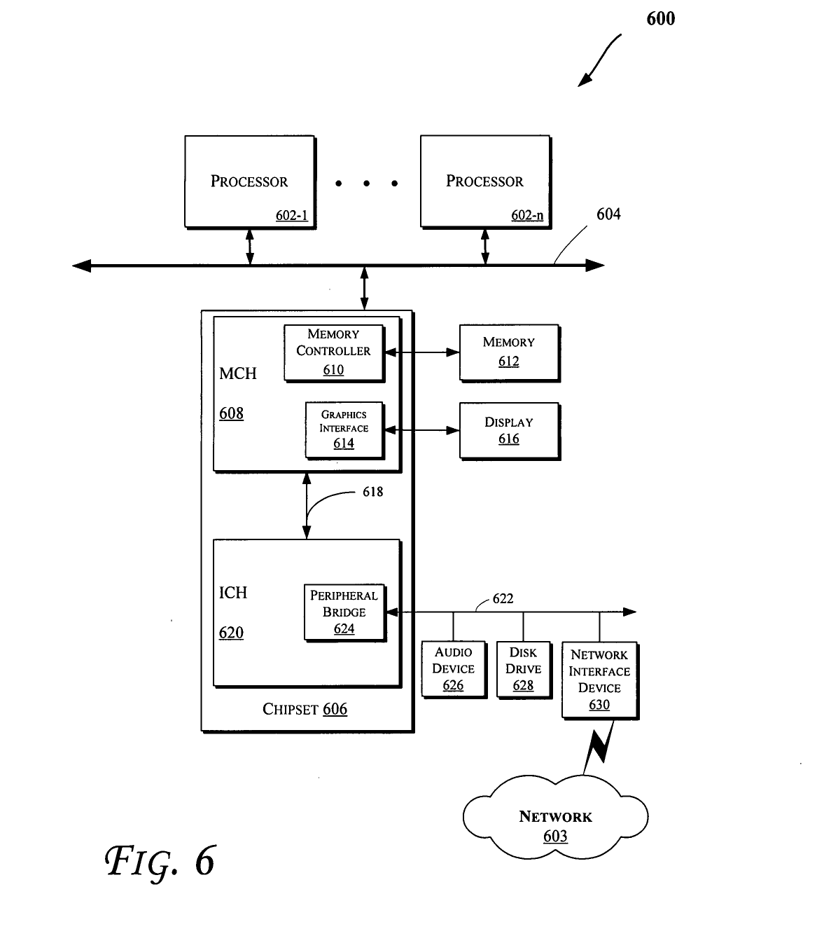

FIG. 6 illustrates a block diagram of an embodiment of a computing system 600. One or more of the devices 104-114 of FIG. 1 and/or devices 210 or 222 of FIG. 2 may comprise the computing system 600. The computing system 600 may include one or more central processing unit(s) (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. Moreover, the operations discussed with reference to FIGS. 1-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612. The memory 612 may store data, including sequences of instructions that are executed by the CPU 602, or any other device included in the computing system 600. In one embodiment of the invention, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The MCH 608 may also include a graphics interface 614 that communicates with a display 616. In one embodiment of the invention, the graphics interface 614 may communicate with the display 616 via an accelerated graphics port (AGP). In an embodiment of the invention, the display 616 may be a flat panel display that communicates with the graphics interface 614 through, for example, a signal converter that translates a digital representation of an image stored in a storage device such as video memory or system memory into display signals that are interpreted and displayed by the display 616. The display signals produced by the interface 614 may pass through various control devices before being interpreted by and subsequently displayed on the display 616.

A hub interface 618 may allow the MCH 608 and an input/output control hub (ICH) 620 to communicate. The ICH 620 may provide an interface to I/O devices that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630, which may be in communication with the computer network 603. In an embodiment, the device 630 may be a NIC capable of wireless communication. In an embodiment, the network 603 may be the same or similar to the networks 102 of FIG. 1 and/or 230 of FIG. 2. In one embodiment, the network interface device 630 may include one or more components of the wireless device 210 of FIG. 2. Also, the device 630 may be the same or similar to the device 210 of FIG. 2 in some embodiments. Other devices may communicate via the bus 622. Also, various components (such as the network interface device 630) may communicate with the MCH 608 in some embodiments of the invention. In addition, the processor 602 and the MCH 608 may be combined to form a single chip. Furthermore, the graphics interface 614 may be included within the MCH 608 in other embodiments of the invention.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions). In an embodiment, components of the system 600 may be arranged in a point-to-point (PtP) configuration. For example, processors, memory, and/or input/output devices may be interconnected by a number of point-to-point interfaces.

In various embodiments of the invention, the operations discussed herein, e.g., with reference to FIGS. 1-6, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include a storage device such as those discussed with respect to FIGS. 1-6.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a buffer to store channel information of a first wireless device; and
logic to process the stored information and cause the processed information to be transmitted to a second wireless device via a crosslink frame structure.

2. The apparatus of 1, wherein the first wireless device comprises the buffer and the logic.

3. The apparatus of claim 1, wherein the channel information corresponds to a wireless channel between the first wireless device and a multiple input, multiple output (MIMO) node.

4. The apparatus of claim 3, wherein the second wireless device communicates with the MIMO node via the wireless channel in accordance with the processed information.

5. The apparatus of claim 3, wherein the MIMO node is to couple one or more of the first or second wireless devices to a wireless network.

6. The apparatus of claim 1, wherein the second wireless device comprises one or more of a processor, a memory, a transceiver, or an antenna.

7. The apparatus of claim 1, further comprising an inverse fast Fourier transform (IFFT) modulator to transform the processed information prior to transmission to the second wireless device.

8. A method comprising:
storing channel information of a first wireless device; and
transmitting the stored channel information to a second wireless device via a crosslink frame structure.

9. The method of claim 8, further comprising transforming the stored channel information prior to the transmission in accordance with an inverse fast Fourier transform (IFFT).

10. The method of claim 8, further comprising receiving preamble data corresponding to a multiple input, multiple output (MIMO) node.

11. The method of claim 10, further comprising determining estimations of the preamble data.

12. The method of claim 11, further comprising scaling the estimates.

13. The method of claim 11, further comprising multiplexing the scaled estimates and a normal preamble to generate the stored channel information.

14. The method of claim 8, further comprising determining crosslink channel estimations corresponding to the transmitted channel information.

15. The method of claim 14, further comprising scaling the crosslink channel estimates.
